(19) United States
(12) Patent Application Publication
(10) Pub. No.: US 2016/0323846 A1
(43) Pub. Date: Nov. 3, 2016

(54) METHOD AND APPARATUS FOR PROVIDING GROUP COMMUNICATION SERVICE ENABLER (GCSE) SERVICE IN WIRELESS COMMUNICATION SYSTEM

(71) Applicant: LG ELECTRONICS INC., Seoul (KR)

(72) Inventors: Kyungmin Park, Seoul (KR); Youngdae LEE, Seoul (KR); Sangwon KIM, Seoul (KR); Jian XU, Seoul (KR); Daewook BYUN, Seoul (KR)

(21) Appl. No.: 15/108,137

(22) PCT Filed: Dec. 29, 2014
(86) PCT No.: PCT/KR2014/012963

§ 371 Date: Jun. 24, 2016

Related U.S. Application Data
(60) Provisional application No. 61/923,779, filed on Jan. 6, 2014.

(51) Int. Cl. H04W 72/00; H04L 5/00; H04W 48/10; H04L 12/18

(52) U.S. Cl. CPC H04W 72/005; H04L 12/185; H04L 5/0032; H04W 48/10

(57) ABSTRACT

In a method for providing an GCSE (Group Communication Service Enabler) service in a wireless communication system, the present invention provides a method for switching from MBMS to unicast service, comprising providing a GCSE (Group Communication Service Enabler) service to a UE through MBMS (Multimedia Broadcast Multicast Services); detecting moving of the UE; receiving MBMS status information indicating whether a neighbor cell belongs to an MBSFN(MBMS Single Frequency Network) area from a MCE (Multi-cell Coordination Entity); based on the MBMS status information, checking whether a target cell of the UE is capable of providing a GCSE service through the MBMS; and transmitting the checking result to the MCE, where in case the target cell is unable to provide a GCSE service through the MBMS, the GCSE service is provided to the UE through a unicast bearer.

### TECHNICAL FIELD

The present invention relates to a wireless communication system and more particularly, a method for providing a GCSE service continuously in a wireless communication system which supports Multimedia Broadcast Multicast Services (MBMS) and an apparatus supporting the method.

### BACKGROUND ART

Mobile communication systems have been developed to provide voice services, while guaranteeing user activity. Service coverage of mobile communication systems, however, has extended even to data services as well as voice services. Recently, an explosive increase in traffic has resulted in shortage of resources and demand for high speed services have led to development of advanced mobile communication systems.

Requirements of a next-generation mobile communication system may include accommodation of huge data traffic, remarkable increase of a transfer rate per user, accommodation of a significantly increased number of connection devices, very low end-to-end latency, and high energy efficiency. To this end, various techniques such as small cell enhancement, dual connectivity, massive multiple input multiple output (MIMO), in-band full duplex, non-orthogonal multiple access (NOMA), supporting super wideband, and device networking are under development.

### DISCLOSURE

### Technical Problem

An object of the present invention is to provide a method for providing a GCSE service to a User Equipment (UE) through MBMS in a wireless communication system and an apparatus supporting the method.

Another object of the present invention is to provide a method and an apparatus for providing a GCSE service smoothly in a wireless communication system even when a UE receiving the GCSE service through MBMS moves.

A yet another object of the present invention is to provide a method and an apparatus for providing a GCSE service continuously in a wireless communication system even when a UE receiving the GCSE service through MBMS moves into a non-MBMS Single Frequency Network (MBSFN) area.

A still another object of the present invention is to provide a method and an apparatus for allocating a unicast bearer to a UE receiving a GCSE service through MBMS in a wireless communication system in case the UE moves to a non-MBSFN area.

A further object of the present invention is to provide a method and an apparatus for reducing a delay caused when a UE receiving a GCSE service through MBMS in a wireless communication system moves to a non-MBSFM area and a unicast bearer is allocated to the UE.

### Technical Solution

To achieve the technical objects above, the present invention provides a method which comprises providing a Group Communication Service Enabler (GCSE) service to a UE through Multimedia Broadcast Multicast Services (MBMS); detecting moving of the UE; receiving MBMS status information indicating whether a neighbor cell belongs to an MBMS Single Frequency Network (MBSFN) area from a Multi-cell Coordination Entity (MCE); based on the MBMS status information, identifying(or checking) whether a target cell of the UE is capable of providing a GCSE service through the MBMS; and transmitting the checking result to the MCE, where in case the target cell is unable to provide a GCSE service through the MBMS, the GCSE service is provided to the UE through a unicast bearer.

The transmitting the checking result to the MCE according to the present invention is carried out when the target cell is unable to provide the GCSE service through the MBMS.

The method according to the present invention further comprises requesting the MCE for the MBMS status information.

The MBMS status information according to the present invention includes at least one of information indicating whether the neighbor cell belongs to the same MBSFN area of a serving cell and a list of neighbor cells belonging to the same MBSFN area.

Also, the present invention provides a method which comprises providing a GCSE service to a UE through MBMS; detecting moving of the UE; in the case of a movement of the UE, receiving from a nearby base station MBMS status information indicating whether a neighbor cell belongs to an MBSFN area; based on the MBMS status information, identifying(checking) whether a target cell of the UE is capable of providing a GCSE service through the MBMS; and transmitting the checking result to the MCE, where in case the target cell is unable to provide a GCSE service through the MBMS, the GCSE service is provided to the UE through a unicast bearer.

The transmitting the checking result to the MCE according to the present invention is carried out when the target cell is unable to provide the GCSE service through the MBMS.

The method according to the present invention further comprises requesting the MCE for the MBMS status information.

The MBMS status information according to the present invention includes at least one of information indicating whether the neighbor cell belongs to the same MBSFN area with a serving cell and a list of neighbor cells belonging to the same MBSFN area.

The information related to a selected cell according to the present invention indicates that the selected cell is unable to provide the service through the MBMS.

An apparatus according to the present invention comprises a Radio Frequency (RF) unit transmitting and receiving a radio signal; and a processor, where the processor is configured to provide a GCSE service to a UE through MBMS; to detect movement of the UE; in the case of a movement of the UE, to receive from a neighboring network entity MBMS status information indicating whether a neighbor cell belongs to an MBSFN area; based on the MBMS status information, to check whether a target cell of the UE is capable of providing the GCSE service through the MBMS; to transmit the checking result to the MCE; and in case the target cell is unable to provide a GCSE service through the MBMS, to provide the GCSE service through a unicast bearer.

The network entity according to the present invention is an MCE of the serving base station or a neighboring base station.

The processor according to the present invention is configured to provide the checking result in case the selected cell is unable to provide the GCSE service through the MBMS.

The processor according to the present invention is further configured to request the MCE for MBMS status information.

The MBMS status information according to the present invention includes at least one of information indicating whether the neighbor cell belongs to the same MBSFN area with a serving cell and a list of neighbor cells belonging to the same MBSFN area.

### Advantageous Effects

A method and an apparatus for providing a GCSE service in a wireless communication system according to the present invention provide the following effects.

The present invention can provide a GCSE service in a wireless communication system through MBMS.

The present invention can provide a GCSE service efficiently in a wireless communication system through unicast bearer configuration in case MBMS is not available.

The present invention can reduce delay caused at the time of unicast bearer configuration applied when MBMS is not available as a UE moves in a wireless communication system.

The effects of the present invention are not limited to the above-described effects and other effects which are not described herein will become apparent to those skilled in the art from the following description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a schematic structure a network structure of an evolved universal mobile telecommunication system (E-UMTS);

FIG. 2a is a block diagram illustrating a function split between an E-UTRAN and an EPC to which the present invention is applied;

FIG. 2b is a block diagram of (a) radio protocol architecture with respect to a user plane and (b) a radio protocol structure with respect to a control plane of a wireless communication system to which the present invention is applied;

FIG. 3 is one example of a physical channel structure to which the present invention is applied;

FIG. 4 illustrates an operation process of a UE and a base station in a competition-based random access procedure;

FIG. 5 illustrates a core network structure for MBMS to which the present invention is applied;

FIG. 6 illustrates structures of an MBMS service area and an MBSFN area to which the present invention is applied;

FIG. 7 is a flow diagram illustrating a procedure for starting an MBMS session to which the present invention is applied;

FIG. 8 is a flow diagram illustrating a procedure for stopping an MBMS session to which the present invention is applied;

FIG. 9 illustrates a procedure according to the present invention for switching from MBMS to unicast;

FIG. 10 is a flow diagram illustrating a procedure for setting up a unicast bearer;

FIG. 11 is a movement path scenario of a UE according to the present invention;

FIGS. 12 to 14 illustrate a specific movement path of a UE to which the present invention is applied, where FIG. 12 illustrates a scenario where a UE moves to a cell belonging to the same MBSFN area of the UE; FIG. 13 illustrates a scenario where a UE moves to a cell belonging to a different MBSFN area; and FIG. 14 illustrates a scenario where a UE moves to a cell belonging to a non-MBSFN area in which an MBMS service is not supported;

FIG. 15 is an embodiment to which the present invention is applied, showing a sequence diagram where a base station of a serving cell receives information related to an MBSFN area from an MCE in MBMS setting;

FIG. 16 is another embodiment to which the present invention is applied, showing a sequence diagram where a base station of a serving cell receives information related to an MBSFN area from a base station of a neighbor cell;

FIG. 17 is a yet another embodiment to which the present invention is applied, showing a flow diagram where a base station of a serving cell transmits target cell-related information to an MCE;

FIG. 18 is a still another embodiment to which the present invention is applied, showing a flow diagram where an MCE receives from a base station of a serving cell information related to a cell to which a UE attempts to move; and

FIG. 19 is a block diagram illustrating a UE and a base station in a wireless communication system according to one embodiment of the present invention.

### MODE FOR INVENTION

Reference will now be made in detail to the preferred embodiments of the present invention, examples of which are illustrated in the accompanying drawings. The detailed description set forth below in connection with the appended drawings is a description of exemplary embodiments and is not intended to represent the only embodiments through which the concepts explained in these embodiments can be practiced. The detailed description includes details for the purpose of providing an understanding of the present invention. However, it will be apparent to those skilled in the art that these teachings may be implemented and practiced without these specific details.

In some instances, known structures and devices are omitted, or are shown in block diagram form focusing on important features of the structures and devices, so as not to obscure the concept of the present invention.

In the embodiments of the present invention, the enhanced Node B (eNode B or eNB) may be a terminal node of a network, which directly communicates with the terminal. In some cases, a specific operation described as performed by the eNB may be performed by an upper node of the eNB. Namely, it is apparent that, in a network comprised of a plurality of network nodes including an eNB, various operations performed for communication with a terminal may be performed by the eNB, or network nodes other than the eNB. The term ‘eNB’ may be replaced with the term ‘fixed station’, ‘base station (BS)’, ‘Node B’, ‘base transceiver system (BTS),’, ‘access point (AP)’, etc. The term ‘user equipment (UE)’ may be replaced with the term ‘terminal’, ‘mobile station (MS)’, ‘user terminal (UT)’, ‘mobile subscriber station (MSS)’, ‘subscriber station (SS)’, ‘Advanced Mobile Station (AMS)’, ‘Wireless terminal (WT)’, ‘Machine-Type Communication (MTC) device’, ‘Machine-to-Machine (M2M) device’, ‘Device-to-Device (D2D) device’, wireless device, etc.

In the embodiments of the present invention, “downlink (DL)” refers to communication from the eNB to the UE, and “uplink (UL)” refers to communication from the UE to the eNB. In the downlink, transmitter may be a part of eNB, and receiver may be part of UE. In the uplink, transmitter may be a part of UE, and receiver may be part of eNB.

Specific terms used for the embodiments of the present invention are provided to aid in understanding of the present invention. These specific terms may be replaced with other terms within the scope and spirit of the present invention.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), ‘non-orthogonal multiple access (NOMA)’, etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE.

For clarity, this application focuses on the 3GPP LTE/LTE-A system. However, the technical features of the present invention are not limited thereto.

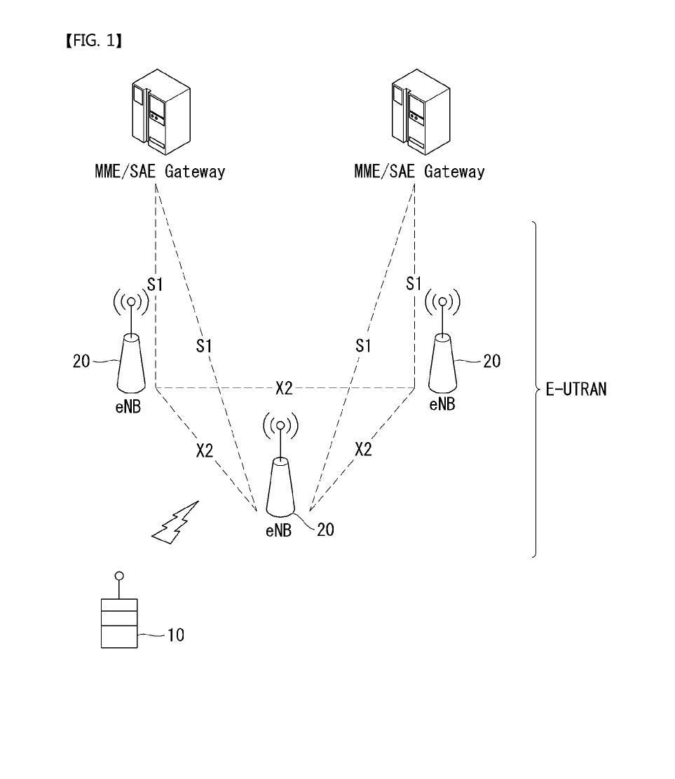

FIG. 1 illustrates a schematic structure a network structure of an evolved universal mobile telecommunication system (E-UMTS).

An E-UMTS system can be regarded as a Long Term Evolution (LTE) or a LIE-Advanced (LTE-A) system. Wireless communication systems are widely deployed to provide various communication services such as voice and packet data services.

With reference to FIG. 1, an E-UTRAN system comprises at least one base station (eNB) 20 which provides a control plane and a user plane to a UE. A UE 10 can be fixed or mobile. An eNB 20 usually refers to a station communicating with a UE 10.

the eNB 20 can provide at least one cell to the UE 10. A cell may refer to a geographic area for which the eNB 20 provides a communication service or refer to a particular frequency band. A cell may correspond to a downlink frequency resource and a uplink frequency resource. Or a cell may correspond to a combination of a downlink frequency resource and an optional uplink frequency resource. In general, if carrier aggregation (CA) is not considered, a single cell always maintains a uplink and a downlink frequency resource in the form of a pair.

An interface for transmission of user traffic or control traffic may be defined between eNBs 20. A source eNB refers to an eNB for which a wireless bearer are currently set with the UE 10, and a target eNB refers to an eNB which attempts to disconnect a wireless bearer linked to the source eNB and perform a handover procedure to establish a new wireless bearer.

eNBs 20 can be connected to one another through X2 interface, where the X2 interface is used for exchanging messages among the eNBs 20. The eNB 20 is connected to an Evolved Packet System (EPS), more specifically a Mobile Management Entity (MME)/Serving Gateway (S-GW) through S1 interface. The S1 interface supports a many-to-many relationship between the eNB 20 and the MME/S-GW. A PDN-GW is used to provide a packet data service to the MME/S-GW. The PDN-GW varies according to the purpose of communication or communication service provided; a PDN-GW supporting a particular service can be found by using Access Point Name(APN) information.

Inter E-UTRAN handover is a basic handover mechanism used at the time of handover between E-UTRAN access networks and divided into X2-based handover and S1-based handover. A UE employs the X2-based handover to carry out handover from a source eNB to a target eNB by using the X2 interface; at this time, the MME/S-GW is not changed.

Due to the S1-based handover, a first bearer, which has been set among the P-GW, MME/S-GW, source eNB, and UE 10, is released, and a new, second bearer is set among the P-GW, MME/S-GW, target eNB, and the UE 10.

The eNBs 20 can transmit the same data packet to multiple users by using a broadcast or multicast method. This method is called a Multimedia Broadcast Multicast Service (MBMS).

MBMS is such a kind of service which transmits the same data packet to multiple users at the same time similarly to the existing Cell Broadcast Service (CBS). However, although the CBS is a low-speed, message-based service, the MBMS is intended for high-speed, multimedia data transmission.

Also, there is another difference between the CBS and the MBMS in that the former is not an Internet Protocol (IP)-based service but the latter is an IP multicast-based service.

If MBMS is employed and a predetermined number of users are in the same cell, the users can receive the same multimedia data by using shared resources (or channel); thus, utilization efficiency of radio resources is improved, and the users can enjoy multimedia services at a low cost.

The MBMS uses a common channel so that a plurality of UEs can receive data efficiently through a single service. With respect to one data service, an eNB allocates one common channel rather than as many dedicated channels as the number of UEs trying to receive the service.

With respect to the MBMS, a UE can receive a service through the MBMS after receiving system information about the corresponding cell through a System Information Block (SIB).

In case a UE 10 leaves an MBMS area while a GCSE service is provided through MBMS that is a broadcast technology or multicast technology, the present invention provides a method to reduce a delay caused when the UE switches to the unicast mode to receive the GCSE service.

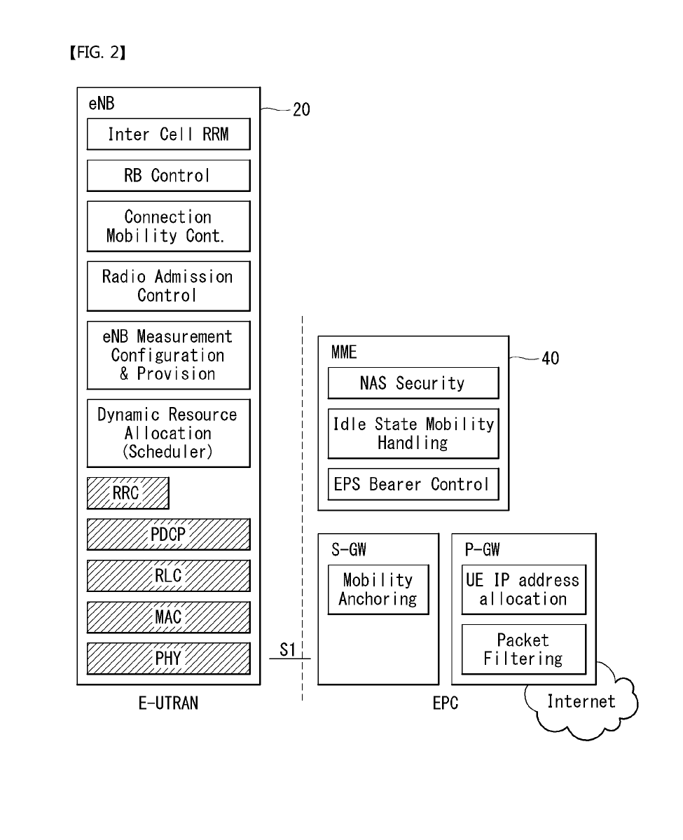

FIG. 2a is a block diagram illustrating a function split between an E-UTRAN and an EPC to which the present invention is applied.

With reference to FIG. 2a, a box with slant lines represents a radio protocol layer, and a white box represents a functional entity of a control plane.

the eNB 20 can perform (1) Radio Resource Management (RRM) such as radio bearer control, radio admission control, connection mobility control, and dynamic resource allocation of a UE 10; (2) IP header compression and encryption of user data streams; (3) routing of user plane data to an S-GW; (4) scheduling and transmission of a paging message; (5) scheduling and transmission of broadcast information; and (6) measurement for mobility and scheduling and measurement report setting.

An MME 40 can perform functions such as (1) Non-Access Stratum (NAS) signaling, (2) NAS signaling security, (3) idle mode UE reachability, (4) tracking area list management, (5) roaming, and (6) authentication.

An SAE Gateway (S-GW) can perform functions such as (1) mobility anchoring and (2) lawful interception; and a PDN-Gateway (P-GW) can perform functions such as (1) IP allocation and (b) packet filtering.

FIG. 2b is a block diagram of (a) radio protocol architecture with respect to a user plane and (b) a radio protocol structure with respect to a control plane of a wireless communication system to which the present invention is applied.

A data plane corresponds to a protocol stack for user data transmission, and a control plane corresponds to a protocol stack for control signal transmission.

To examine the common radio protocol architecture of (a) the user plane and (b) the control plane with reference to FIG. 2b, the PHY layer provides an information transfer service to a upper layer by using a physical channel. The PHY layer is connected to upper layers such as the Medium Access Control (MAC) layer through a transport channel.

Data move between the MAC layer and the PHY layer through the transport channel. A transport channel is classified according to how data move through a radio interface and in what characteristics. Data move between disparate physical layers, namely between physical layers of a transmitter and a receiver, through a physical channel. There are several physical control channel defined.

A Physical Downlink Control Channel (PDCCH) informs a UE about information about resource allocation of a Paging Channel (PCH) and a Downlink Shared Channel (DL-SCH) and Hybrid Automatic Repeat Request (HARQ) information related to DL-SCH.

A PDCCH can transmit a uplink scheduling grant which informs a UE about resource allocation for uplink transmission. A Physical Control Format Indicator Channel (PCFICH) informs a UE about the number of OFDM symbols used by PDCCHs and is transmitted for each subframe. A Physical Hybrid ARQ Indicator Channel (PHICH) can transmit a HARQ ACK/NAK signal in response to uplink transmission.

A Physical Uplink Control Channel (PUCCH) can transmit HARQ ACK/NAK with respect to downlink transmission, scheduling request and uplink control information such as Channel Quality Indicator (CQI). A Physical Uplink Shared Channel (PUSCH) can transmit a Uplink Shared Channel (UL-SCH).

The function of the MAC layer includes mapping between a logical channel and a transport channel; and multiplexing/demultiplexing of a transport block provided to a physical channel through a transport channel of a MAC Service Data Unit (SDU) belonging to the logical channel. The MAC layer provides a service to a Radio Link Control (RLC) layer through the logical channel. The logical channel can be divided into a control channel for transmission of control area information and a traffic channel for transmission of user area information.

The function of the RLC layer includes concatenation, segmentation, and reassembly of RLC SDUs. To ensure different levels of Quality of Service (QoS) requested by a Radio Bearer (RB), the RLC layer provides three operation modes: Transparent Mode (TM), Unacknowledged Mode (UM), and Acknowledged Mode (AM). The AM RLC provides an error correction function through Automatic Repeat Request (ARQ).

(a) The function of a Packet Data Convergence Protocol (PDCP) layer in the user plane includes transmission of data, header compression, and ciphering(or encryption). The function of the PDCP layer in the user plane includes transmission of control plane data and encryption/integrity protection.

(b) The RRC layer in the control plane carries out the function of configuration of Radio Bearers (RBs); and control of a logical, a transport, and a physical channel with respect to re-configuration and release of the RBs. An RB refers to a logical path provided by a first layer (PHY layer) and a second layer (MAC layer, RLC layer, PDCP layer) for transmission of data between a UE and a network. An RB is set up through a process of defining a radio protocol layer and channel characteristics to provide a particular service and determining individual parameters; and a method for operating the radio protocol layer and the channel.

An RB can be further divided into a Signaling RB (SRB), a Data RB (DRB), and an MBMS PTM RB (MRB). An SRB is used as a passage to transmit an RRC message in the control plane, and a DRB is used as a passage to transmit user data in the user plane. An MRB is used as a passage to transmit data by using MBMS.

In the present invention, a UE can receive an MBMS service from an eNB through an MRB if the UE belongs to the MBMS service zone. Once the UE is located in the MBMS service zone, the UE can continuously receive the same service even if a current cell of the UE is changed according to the movement thereof.

However, if the cell in which the UE moves does not support the MBMS service, the UE needs to establish a separate unicast bearer to provide the service continuously.

A Non-Access Stratum (NAS) layer located on top of the RRC layer carries out a function of session management and mobility management.

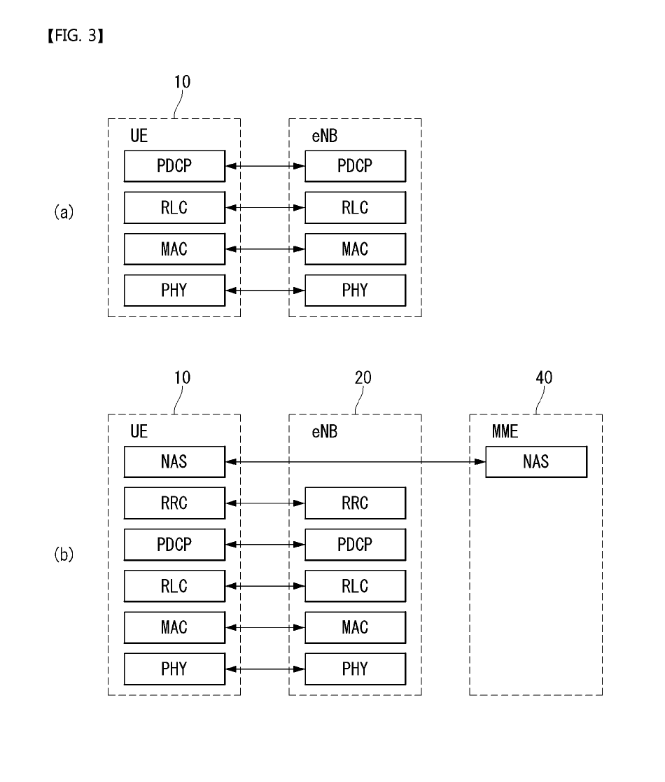

FIG. 3 is one example of a physical channel structure to which the present invention is applied.

A physical channel comprises a plurality of subframes and a plurality of subcarriers in the frequency domain. One subframe comprises a plurality of symbols in the time domain. One subframe comprises a plurality of resource blocks (RBs), and one RB comprises a plurality of symbols and a plurality of subcarriers.

Each subframe can make use of particular subframes of particular symbols of the corresponding subframe with respect to a PDCCH. For example, a first symbol of a subframe can be used for the PDCCH. A Transmission Time Interval (TTI), which is a time unit for data transmission, can be the same as the length of one subframe.

A DL transmission channel through which data are transmitted from a network to a UE includes a Broadcast Channel (BCH) transmitting system information, a Paging Channel (PCH) transmitting a paging message, and a DL-SCH transmitting user traffic or a control signal.

System information block carries one or more system information, and each system information block can be transmitted at the same period. Traffic or a control signal of MBMS is transmitted through a Multicast Channel (MCH).

Meanwhile, the UL transmission channel which transmits data from a UE to a network includes a Random Access Channel (RACH) transmitting an initial control message and a UL-SCH transmitting user traffic or a control signal.

A Packet Data Convergence Protocol (PDCP) layer belongs to L2. The function of the PDCP layer in the user plane includes transmission of user data, header compression, and ciphering(or encryption).

Header compression carries out a function of reducing the size of an IP packet header which holds relatively big, unnecessary control information to support efficient transmission in a wireless communication interval with narrow bandwidth. The function of the PDCP layer in the control plane includes transmission of control plane data and encryption/integrity protection.

The MCH, which is a transmission channel for MBMS, can be mapped to a Multicast Control Channel (MCCH), which is a logical channel for a control signal, and a Multicast Traffic Channel (MTCH), which is a logical channel for data. The MCCH transmits an MBMS-related RRC message, and the MTCH transmits service traffic of particular MBMS.

One MCCH channel can be formed in each MBMS Single Frequency Network (MBSFN) area which transmits the same MBMS information and traffic. If a single cell provides a plurality of MBSFN areas, a UE may receive a plurality of MCCHs.

If an MBMS-related RRC message is changed in a particular MCCH, the PDCCH can transmit an MBMS Radio Network Temporary Identity (M-RNTI) and an MCCH indicator indicating a particular MCCH. A UE which supports MBMS can receive an M-RNTI and an MCCH indicator through the PDCCH, determine that an MBMS-related RRC message has been changed in a particular MCCH, and receive the particular MCCH.

The RRC message of an MCCH can be changed at each change period and can be broadcast repeatedly at each repetition period.

A UE can receive traffic of an MBMS service through the MTCH. However, if the UE leaves the MBMS service area, traffic of the MBMS service can no longer be received through the MTCH.

Therefore, in order for the UE to continuously receive a service which has been provided by an eNB, a separate, dedicated channel rather than the MTCH meant for unicast needs to be formed.

The present invention provides an efficient method intended for a case where a separate, dedicated channel needs to be formed for the UE.

FIG. 4 illustrates an operation process of a UE and an eNB in a competition-based random access procedure.

(1) Transmission of a First Message

First, a UE selects a random access preamble randomly from among a set of random access preambles specified by system information or a handover command. The UE selects a Physical RACH (PRACH) resource capable of transmitting the random access preamble and transmits the selected random access preamble.

(2) Reception of a Second Message

After transmitting a random access preamble, a UE attempts to receive a random access response in a random access reception window specified by an eNB through system information or a handover command; and receives a PDSCH through the corresponding RA-RNTI information. Through reception of the PDSCH, the UE can receive a uplink (UL) grant, a temporary C-RNTI, and a Timing Advance Command (TAC).

(3) Transmission of a Third Message

If a UE receives a valid random access response, the UE processes the information carried by the random access response. In other words, the UE applies a TAC and stores a temporary C-RNTI. Also, by using a UL grant, the UE transmits data (namely, the third message) to an eNB. The third message should include an identifier of the UE. In a competition-based random access procedure, an eNB is unable to determine which UE performs the random access procedure; this is so because a UE should be identified to resolve contention in a subsequent stage.

Two methods have been taken into account as a method for including an identifier of a UE. In the first method, if a UE holds a valid cell identifier assigned by the corresponding cell already before the random access procedure, the UE transmits its cell identifier through a uplink transmission signal corresponding to the UL grant.

On the other hand, if the UE has failed to receive a valid cell identifier before the random access procedure, the UE transmits its unique identifier (for example, S-TMSI or a random ID). In most cases, the unique identifier is longer than a cell identifier. The UE, after transmitting data corresponding to the UL grant, starts a contention resolution timer.

(4) Reception of a Fourth Message

A UE, after transmitting data including its identifier through a UL grant included in a random access response, waits for an eNB to issue a command meant for contention resolution. In other words, the UE attempts reception of a PDCCH to receive a particular message. In this case, too, two methods have been taken into account as a method for receiving the PDCCH.

As described earlier, if a third message transmitted in accordance to the UL grant, the UE attempts to receive a PDCCH by using its cell identifier. In case the identifier is unique, the UE can attempt to receive a PDCCH by using a temporary C-RNTI included in a random access response. Afterwards, in the former case, if the UE receives a PDCCH through its cell identifier before the contention resolution timer is terminated, the UE determines that the random access procedure has been carried out normally and terminates the random access procedure.

In the latter case, if the UE has received a PDCCH through a temporary C-RNTI before the contention resolution timer is terminated, the UE check the data transmitted through a PDSCH specified by the PDCCH. If the UE's unique identifier is contained in the data, the UE determines that the random access procedure has been carried out normally and terminates the random access procedure.

In what follows, an RRC state of a UE and an RRC connection method will be described in detail.

An RRC state refers to a state representing whether an RRC layer of a UE is connected logically to an RRC layer of an E-UTRAN. In case the two RRC layers are connected to each other, it is called an RRC_Connected state, whereas it is called an RRC_Idle state in the opposite case. If a UE stays in the RRC_Connected state, an E-UTRAN can know existence of the corresponding UE at a cell scale; therefore, the E-UTRAN can control the UE in an effective manner.

On the other hand, a UE in the RRC_Idle state cannot be identified by the E-UTRAN, and a Core Network (CN) is used to manage the UE in units of a tracking area which is larger than a cell. In other words, a UE in the RRC_Idle state can only be identified in a large area unit and should move to the RRC_Connected state to receive conventional mobile communication services such as voice and data communication.

If the user turns on power of the UE for the first time, the UE searches for an appropriate cell and stays there in the RCC_Idle state. The UE in the RRC_Idle state establishes an RRC connection to the E-UTRAN through an RRC connection procedure only when there is a need for the RRC connection, after which the UE changes its state to the RRC_Connection state. There are many cases where a UE in the RRC_Idle state needs to establish an RRC connection, including a case where uplink data transmission is required according as the user attempts to make a call or a case where a response message is transmitted in response to reception of a paging message from the E-UTRAN.

The NAS layer located on top of the RRC layer carries out a function of session management and mobility management.

Two states are defined to manage mobility of a UE in the NAS layer: EPS Mobility Management-REGISTERED (EMM-REGISTERED) and EMM-DEREGISTERED. In the initial stage, a UE stays in the EMM-DEREGISTERED state, and in order for the UE to connect to a network, the UE carries out a process of registering for the corresponding network through an initial attach procedure. If the attach procedure is carried out successfully, the UE and the MME move to the EMM-REGISTERED state.

To manage a signaling connection between a UE and an EPC, an EPS Connection Management (ECM)-IDLE state and an ECM-CONNECTED state are defined, where the two states are applied to the UE and the MME. If a UE in the ECM-IDLE state establishes an RRC connection to the E-UTRAN, the corresponding UE moves to the ECM-CONNECTED state.

If the MME in the ECM-IDLE state establishes an S1 connection to the E-UTRAN, the MME makes a transition to the ECM-CONNECTED state. If the UE is in the ECM-IDLE state, context information of the UE is not provided to the E-UTRAN. Therefore, the UE in the ECM-IDLE state carries out a mobility-related procedure based on the UE such as cell selection or cell reselection without having to wait for a command from the network. On the other hand, if the UE is in the ECM-CONNECTE state, the UE's mobility is managed by the command of the network. In case the location of the UE changes in the ECM-IDLE state changes from the location known to the network, the UE informs the network about the corresponding location of the UE through a tracking area update procedure.

In what follows, descriptions of system information will be provided.

System information includes essential information that a UE should know to connect to an eNB. Therefore, the UE should receive all of the system information before connecting to an eNB and always have the most recent system information. Since the system information is such kind of information that all of the UEs within the same cell should know, an eNB transmits the system information periodically.

According to Section 5.2.5 of the 3GPP TS 36.331 V8.7.0 (2009-09) “Radio Resource Control (RRC); Protocol specification (Release 8), the system information is divided into a Master Information Block (MIB), Scheduling Block (SB), and System Information Block (SIB). An MIB enables a UE to know a physical structure of the corresponding cell, for example, bandwidth. An SB provides transmission information of SIBs, for example, transmission period. An SIB is a set of system information in association with each other. For example, some SIB includes only the information of a neighbor cell while another SIB includes only the information of a uplink radio channel used by the UE.

In general, services provided by a network to a UE can be divided into the following three types. Also, according to which service is available, a UE recognizes the type of the corresponding cell differently. In what follows, service types are described first, after which cell types are described subsequently.

1) Limited service: this service provides an emergency call and Earthquake and Tsunami Warning System (ETWS) and is provided in an acceptable cell.

2) Normal service: this service refers to a service of public use and is provided in a suitable or normal cell.

3) Operator service: this service is intended for communication network service providers, and the corresponding cell can be accessed only by a communication network service provider while an ordinary user is not allowed to access the corresponding cell.

With respect to the type of a service by a cell, cell types can be divided as follows.

1) Acceptable cell: a cell from which a UE can receive a limited service. This cell is not barred in view of the corresponding UE and satisfies a cell selection criterion of the UE.

2) Suitable cell: a cell from which a UE receives a normal service. This cell satisfies a condition of an acceptable cell and at the same time, satisfies additional conditions. Additional conditions require that the cell should belong to a Public Land Mobile Network (PLMN) that can be accessed by the corresponding UE and a UE should be allowed to carry out a tracking area update procedure in the cell. If the corresponding cell is a CSG cell, a UE should be able to access the cell as a CSG member.

3) Barred cell: through system information, this cell broadcasts that access to the cell is barred.

4) Reserved cell: through system information, this cell broadcasts that it is reserved.

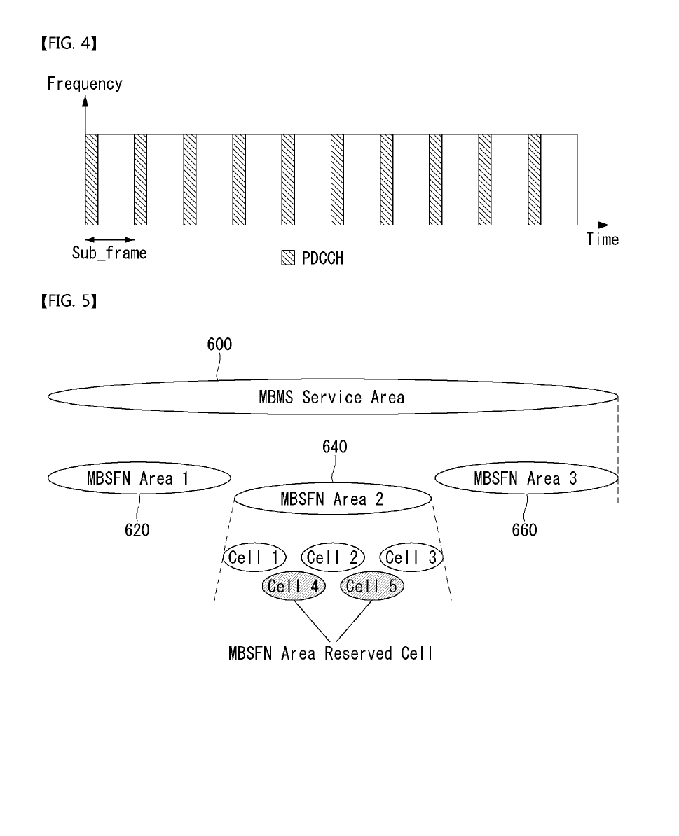

FIG. 5 illustrates a core network structure for MBMS to which the present invention is applied.

The core network of MBMS is divided into an E-UTRAN and an Evolved Packet Core (EPC) part dealing with core network-related technologies.

With reference to FIG. 5, an E-UTRAN again includes a Multi-cell Coordination Entity (MCE) 30 and an eNB 1, 20.

The MCE 30 is a primary entity which controls MBMS, carrying out the role of session management of the eNB 1, 20 in an MBSFN area, radio resource allocation, or admission control. The MCE 30 can be implemented within the eNB 1, 20 or separately from the eNB 1, 20.

The MCE 30 and the eNB 1, 20 is connected to each other through M2 interface. The M2 interface is an internal control plane interface of the E-UTRAN, to which MBMS control information is transmitted. The M2 interface can be defined only in a logical form if the MCE 30 is implemented within the eNB 1, 20.

The EPC part dealing with core network-related technologies comprises an MME 40 and an MBMS Gateway (GW) 50.

The MME 40 carries out the operation of NAS signaling, authentication, selection of a PDN GW and SAE GW (S-GW), MME selection for handover due to the change of the MME, reachability with respect to a UE in the Idle mode, AS security control, and so on.

The MBMS GW 50 is an entity transmitting MBMS service data, located between the eNB 1, 20 and the BM-SC 60. The MBMS GW 50 carries out the operation of MBMS packet transmission to the eNB 1, 20 and broadcasting. The MBMS GW 50 employs a PDCP and IP multicast to transmit user data to the eNB 1, 20 and carries out session control signaling with respect to the E-UTRAN.

M1 interface, which is the user plane interface, is used as an interface between the eNB 1, 20 and the MBMS GW 50. Service data provided through the MBMS are transmitted through the M1 interface.

The control plane interface between the E-UTRAN and the EPC is used as an interface between the MME 40 and the MCE 30, which is called M3 interface. Control information related to MBMS session control is transmitted through the M3 interface.

The MME 40 and the MCE 30 transmit session control signaling such as a message meant for session start or stop to the eNB 1, 20. The eNB 1, 20 can inform the UE about start or suspension of the corresponding MBMS service through cell notification.

There are times when a UE 10 changes a current cell due to movement of the user while the UE 10 is receiving a service through MBMS. If a new cell does not support the MBMS service, in other words, if the cell does not belong to the MBSFN area, the UE may become unable to receive a service continuously through the MBMS.

If the UE wants to receive the service again, a separate unicast bearer needs to be established to do so. However, to establish the unicast bearer, the UE may have to not only consume additional battery life but also deal with an extra delay.

Such time delay may lead to a serious problem, particularly for video streaming and voice services where real-time transmission of data is of paramount importance. Therefore, a method for dealing with the time delay is needed.

The present invention proposes a method and an apparatus for reducing a time delay if a UE establishes a separate unicast bearer.

FIG. 6 illustrates structures of an MBMS service area and an MBSFN area to which the present invention is applied.

With reference to FIG. 6 an MBMS service area 600 refers to an area in which a particular MBMS service is provided. A Multimedia Broadcast Multicast Service Single Frequency Network (MBSFN) area denotes a single frequency band where a particular MBMS service is provided.

In the MBSFN area 1, 620, an MBSFN subframe is allocated at the same frequency through MBMS to provide the same service. For example, as shown in FIG. 6, the MBSFN area 1, 620 assigns an MBSFN subframe to the frequency 1 to support a particular MBMS service.

At this time, although the MBSFN area 2, 640 is also capable of providing the same service as the MBSFN area 1, 620, the MBSFN area 2, 640 can provide the same service by using a frequency different from the frequency employed in the MBSFN area 1, 620. In case a UE moves within the same MBSFN area, the UE can still receive the same service as long as the UE stays in the same frequency band even if the UE moves to another cell.

However, if the UE leaves the MBMS service area 600 or moves to an MBSFN area reserved cell, the UE becomes unable to get a service through the MBMS anymore and needs to establish a separate unicast bearer to continuously receive a service.

The MBSFN area can include a group of cells within an MBSFN synchronization area of a network. As shown in FIG. 6, the MBSFN area 2, 640 comprises Cell 1, 2, 3, 4, and 5.

All of the cells in the MBSFN area except for MBSFN area reserved cells can perform MBSFN transmission. For example, in the MBSFN area 2, 640, except for the MBSFN area reserved cells, Cell 4 and 5, Cell 1, 2, and 3 can perform MBSFN transmission.

Suppose a UE receiving a service through MBMS moves to a cell in which a service is not provided through the MBMS. The present invention provides an effective method and apparatus for establishing a unicast bearer to continuously receive a service in such a situation.

In what follows, an MBMS session start/stop procedure and a procedure for establishing a unicast bearer will be described.

MBMS Session Start Procedure

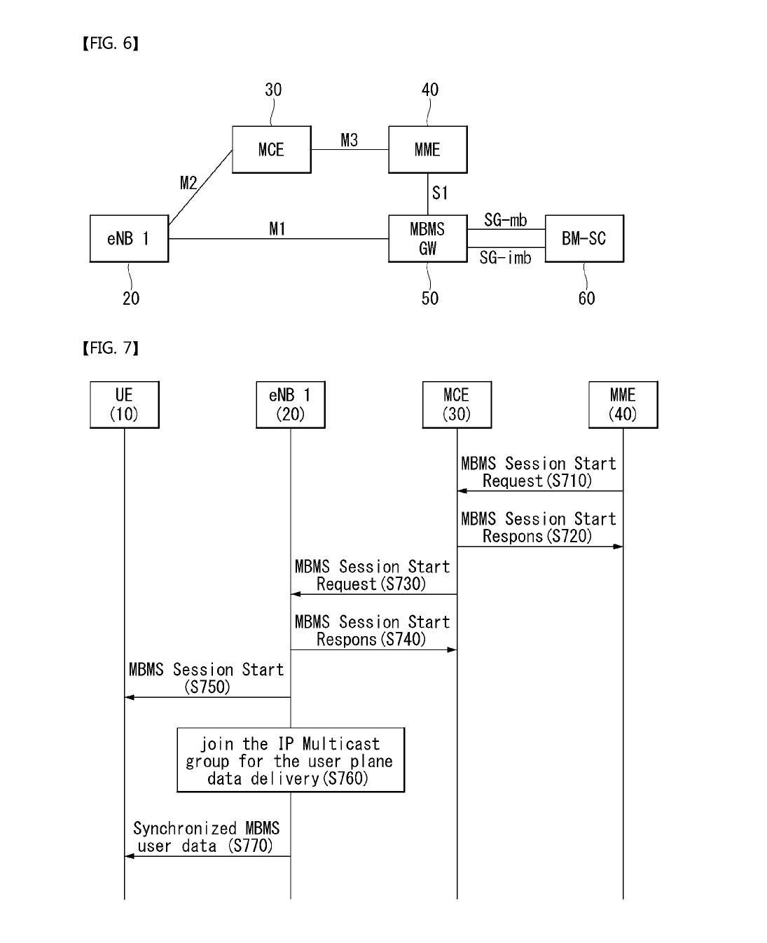

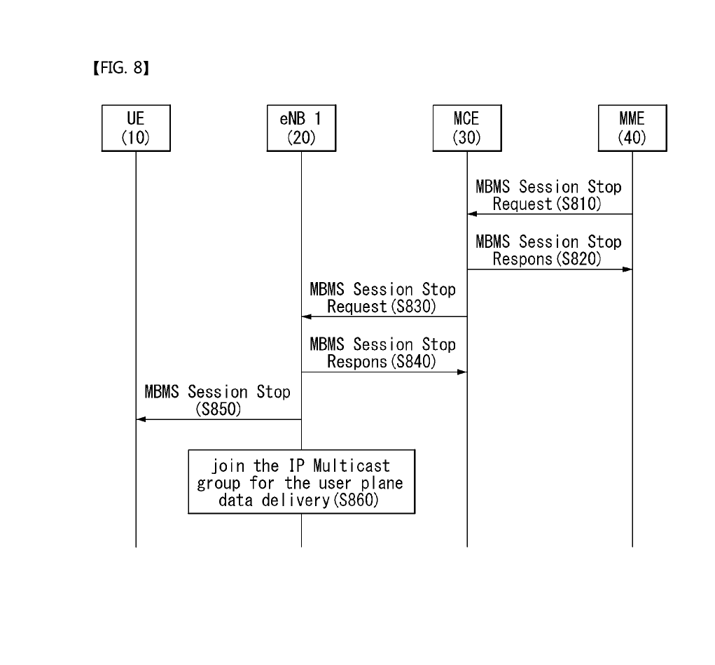

FIG. 7 is a flow diagram illustrating a procedure for starting an MBMS session to which the present invention is applied.

With reference to FIG. 7, if the MME 40 forms an MBMS bearer, the UE 10 belonging in the MBSFN area within the MBMS area can receive a service through MBMS.

To examine the above procedure more specifically, the MME 40 transmits an MBMS session start request message to the MCE 30 which controls the eNB 1, 20 belonging in the MBMS area S710. The MBMS session start request message can include at least one of an IP multicast address, session attributes, or the minimum time period required before first data are transmitted.

The MCE 30 receiving the MBMS session start request message can check whether radio resources for a new MBMS service are sufficient. If the radio resources are not sufficient, the MCE 30 can stop establishing a radio bearer of the MBMS service.

In case the MCE 30 determines that the radio resources are sufficient, the MCE 30 transmits an MBMS session start response message to the MME 40 in response to the MBMS session start request message S720.

The MCE 30 transmits the MBMS session start request message to the eNB 1, 20 belonging to the MBMS service area S730. The eNB 1, 20 which receives the MBMS session start request message, transmits an MBMS session start response message to the MCE 30 in response to the MBMS session start request message S740.

The eNB 1, 20, by changing an MCCH and transmitting updated MCCH information to the UE 10, can notify of the MBMS session start S750.

Next, the eNB 1, 20 enters an IP multicast group to receive MBMS user plane data 5760. The eNB 1, 20 which has entered the IP multicast group transmits data for a radio interface to the UE 10, 5770.

Once an MBMS bearer is established through the aforementioned procedure, the UE 10 can receive a service through a common channel. Also, even if the UE 10 moves, the UE 10 can receive the service continuously through MBMS as long as the cell to which the UE 10 has moved belongs to the area capable of providing services through MBMS.

MBMS Session Stop Procedure

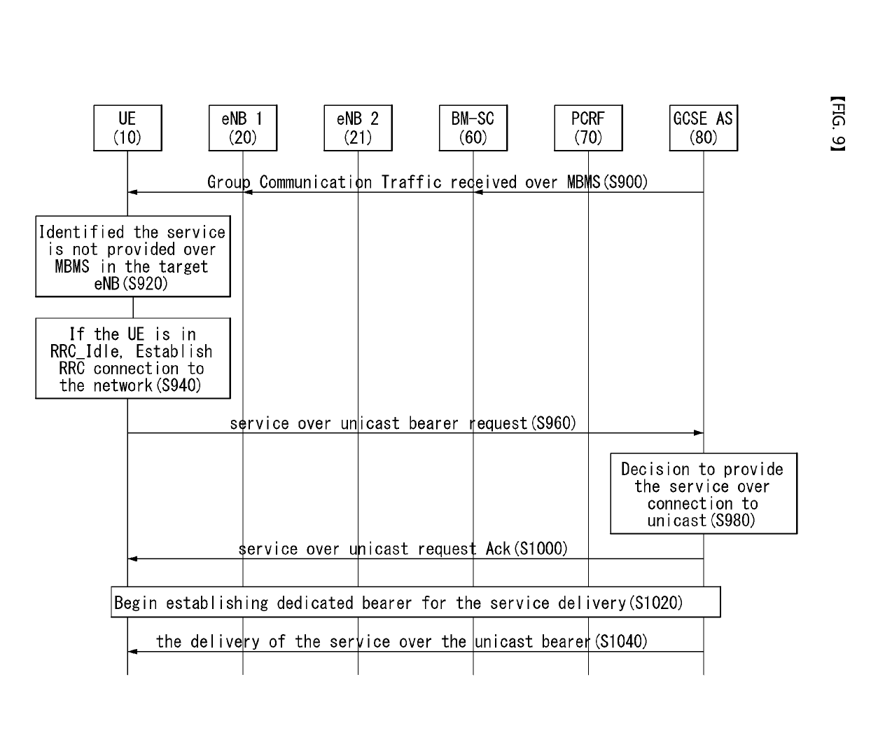

FIG. 8 is a flow diagram illustrating a procedure for stopping an MBMS session to which the present invention is applied.

With reference to FIG. 8, if the MME 40 issues an MBMS service stop request to stop providing a service through MBMS, the eNB 1, 20 informs the UE 10 about a service through MBMS to be stopped, thereby eventually stopping the MBMS service.

To examine the aforementioned operation more specifically, the MME 40 transmits an MBMS session stop request message to the MCE 30 which controls the eNB 1, 21 belonging to the MBMS area 5810.

The MCE 30 transmits an MBMS session stop response message to the MME 40 in response to the MBMS session stop request message S820 and transmits an MBMS session stop request message to the eNB 1, 21, S830.

The eNB 1, 21 which has checked the MBMS session stop request message transmits an MBMS session stop response message to the MCE 30 in response to the MBMS session stop request message S850.

The eNB 1, 20 notifies the UE 10 about stopping of an MBMS session by deleting service composition of an updated MCCH message S850.

The eNB 1, 20 releases an E-RAB related to service provision through MBMS and leaves an IP multicast group, thereby stopping service provision through MBMS S860.

Handover Procedure

In general, handover refers to a function of a UE switching a communication channel of a current source station to a communication channel of a neighbor station of a different radio area, namely, a target station (or a target node) when the UE moves from the current source station (or a source node) to a radio area of the neighbor station.

According to the present invention, in the case of movement of a UE which has been receiving a service from a serving cell through the MBMS session start procedure, the UE may leave the current serving cell and carry out handover to a different, neighbor cell.

Handover of the UE from a source cell to a neighbor cell within the same frequency band is called intra-frequency handover; handover of the UE from a source cell to a neighbor cell belonging to a different frequency band is called inter-frequency handover.

A source cell in a handover procedure refers to a cell in which the UE 10 currently receives a service while a neighbor cell refers to a cell adjacent to the source cell geographically or in the frequency domain.

A neighbor cell to which a UE moves is called a target cell. An eNB which provides a target cell is called a target eNB. One eNB may provide both of the source and the target cell, or the two cells can be provided by the respective eNBs.

In what follows, for the convenience of description, it is assumed that a source cell and a target cell are provided by different eNBs, namely, a source eNB and a target eNB. Therefore, a source eNB and a source cell; and a target eNB and a target cell can be used interchangeably.

According to the present invention, in case the UE 10 receiving a service through MBMS changes its location and leaves the MBMS service area, the UE 10 can attempt to establish a unicast bearer to continuously receive the service.

A neighbor cell which uses the same carrier frequency with respect to a source cell is called an intra-frequency neighbor cell. Similarly, a neighbor cell which uses a different carrier frequency with respect to a source cell is called an inter-frequency neighbor cell.

In other words, not only the cell using the same frequency with a source cell but also the cell using a different frequency from the source cell can be called a neighbor cell as far as the cell is adjacent to the source cell.

Procedure for Switching from MBMS to Unicast

FIG. 9 illustrates a procedure according to the present invention for switching from MBMS to unicast. At this time, the eNB 1, 20 represents a source station providing a source cell, and the eNB 2, 21 represents a target station providing a target cell to which the UE intends to move.

To examine the procedure for switching from MBMS to unicast specifically with reference to FIG. 9, the UE 10 is connected to the eNB 1, 20, and the eNB 1, 20 belongs to the MBSFN area of an MBMS area, providing a GCSE service through MBMS.

The UE 10, being connected to the eNB 1, 20, receives group communication traffic from a GCSE Application Server (AS) through MBMS S900. In case the UE 10 moves to a neighbor cell in which the GCSE service is being provided through MBMS, the UE 10 performs handover to the neighbor cell.

The UE 10 can determine whether it can continuously receive the GCSE service from the eNB 2, 21 of the target cell through MBMS, which can be known as the UE 10 moves to the target cell and checks a System Information Block (SIB) 13.

At this time, if the UE performs handover to a cell belonging to the MBSFN area or the UE moves to a different MBSFN area but the same GCSE service is provided at the same frequency or at a different frequency in the new MBSFN area, the UE 10 can receive the GCSE service continuously through MBMS.

However, if the UE 10 moves to a different MBSFN area not providing the same service or completely gets out of the MBMS area, the UE 10 is unable to continuously receive the GCSE service through MBMS.

In case the UE 10 is unable to receive the GCSE service through MBMS, it can still receive the GCSE service through a unicast bearer.

In this case, if the UE 10 stays in the RRC_Idle state, the UE 10 attempts to set up an RRC connection to the network of the eNB 2, 21 to establish a unicast bearer S940.

The UE 10 which has set up an RRC connection requests the GCSE AS 80 to provide a unicast bearer service so that the UE 10 can receive the GCSE service through the unicast bearer rather than MBMS S960.

The GCSE AS 80 receiving the request determines whether to provide the GCSE service to the UE 10 through a unicast bearer S980 and transmits a response to the request to the UE 10 in case the GCSE AS 80 determines to provide the GCSE service through a unicast bearer S1000.

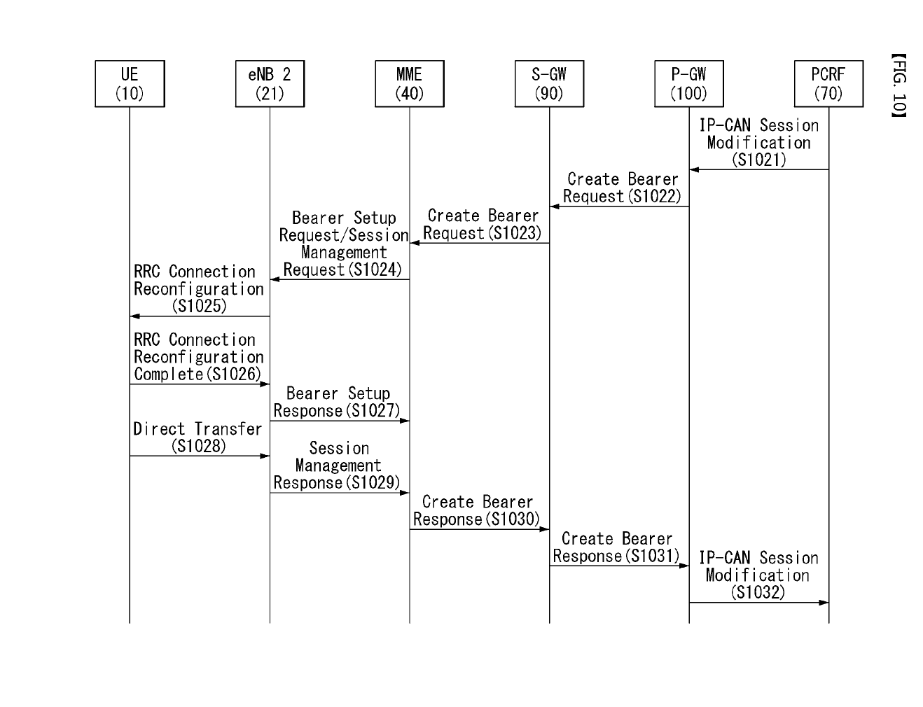

Next, the GCSE AS 80 and the UE 10 performs a step for setting up a unicast bearer S1020. A method for setting up a unicast bearer will be described in detail with reference to FIG. 10.

The UE 10 for which the unicast bearer has been set up is now able to continuously receive the GCSE service through the unicast bearer from the GCSE AS 80, S1040. However, an unavoidable delay may be caused during the procedure of switching from MBMS to the unicast bearer.

The delay can be caused from a procedure for recognizing the UE 10′s inability to receive the GCSE service from the eNB 2, 21 through MBMS, a procedure for switching from RRC_Idle to RRC_Connection state, or a procedure for setting up a unicast bearer, where a method for resolving the cause will be described below.

In what follows, a procedure for setting up a unicast bearer will be described in detail with reference to FIG. 10.

Procedure for Unicast Bearer Set Up

FIG. 10 is a flow diagram illustrating a procedure for setting up a unicast bearer.

With reference to FIG. 10, if a target eNB to which the UE 10 attempts handover is unable to provide a GCSE service through MBMS, the UE 10 sets up a unicast bearer to receive the GCSE service. In what follows, the target eNB is denoted by eNB 2, 21.

To examine the aforementioned operation more specifically, if dynamic PCC is deployed, the PCRF(70) sends a PCC decision provision (QoS policy) message to the P-GW(100)(S1021).

This corresponds to the initial steps of the PCRF-Initiated IP-CAN (IP Connectivity Access Network) Session Modification procedure or to the PCRF(70) response in the PCEF initiated IP-CAN Session Modification procedure, up to the point that the P-GW(100) requests IP-CAN Bearer Signalling.

The PCC decision provision message may indicate that User Location Information and/or UE Time Zone Information is to be provided to the PCRF(70). If dynamic PCC is not deployed, the P-GW(100) may apply local QoS policy.

The P-GW(100) uses this QoS(quality of Service) policy to assign the EPS Bearer QoS, i.e., it assigns the values to the bearer level QoS parameters QCI, ARP, GBR and MBR. The PDN GW generates a Charging Id for the dedicated bearer.

The P-GW(100) sends a Create Bearer Request message to the S-GW(90)(S1022). The Create Bearer Request message includes International Mobile Subscriber Identity (IMSI), Procedure Transaction Id (PTI), EPS Bearer QoS, Traffic Flow Template (TFT), S5/S8 Tunnel End Point Identifier (TEID), Charging Id, Linked EPS Bearer Identity (LBI) and Protocol Configuration Options (PCO).

The LBI is the EPS Bearer Identity of the default bearer. The PTI parameter is only used when the procedure was initiated by a UE(10) Requested Bearer Resource Modification Procedure. The Protocol Configuration Options may be used to transfer application level parameters between the UE(10) and the P-GW(100), and are sent transparently through the MME(40) and the S-GW(90). Here, the PCO is sent in the dedicated bearer activation procedure either in response to a PCO received from the UE, or without the need to send a response to a UE(10) provided PCO e.g. when the network wants the bearer to be dedicated for IMS signalling.

The S-GW(90) sends the Create Bearer Request message to the MME(40) (S1023). The Create Bearer Request message includes IMSI, PTI, EPS Bearer QoS, TFT, S1-TEID, PDN GW TEID (GTP-based S5/S8), LBI and Protocol Configuration Options.

If the UE(10) is in ECM-IDLE state the MME(40) will trigger the Network Triggered Service Request from step S1023. In that case the following steps S1024-S1027 may be combined into Network Triggered Service Request procedure or be performed stand-alone.

The MME(40) selects an EPS Bearer Identity, which has not yet been assigned to the UE(10). The MME(40) then builds a Session Management Request including the PTI, TFT, EPS Bearer QoS parameters (excluding ARP), Protocol Configuration Options, the EPS Bearer Identity and the Linked EPS Bearer Identity (LBI). If the UE(10) has UTRAN or GERAN capabilities and the network supports mobility to UTRAN or GERAN, the MME(40) uses the EPS bearer QoS parameters to derive the corresponding PDP context parameters QoS Negotiated (3GPP Release 1999 QoS profile), Radio Priority, Packet Flow Id and Transaction Identifier (TI) and includes them in the Session Management Request. If the UE(10) indicated in the UE Network Capability it does not support Base Station Subsystem (BSS) packet flow procedures, then the MME(40) shall not include the Packet Flow Id. The MME(40) then signals the Bearer Setup Request message to the eNB 2(21)(S1024). The Bearer Setup Request message includes EPS Bearer Identity, EPS Bearer QoS, Session Management Request and S1-TEID.

The eNB 2(21) maps the EPS Bearer QoS to the Radio Bearer QoS. It then signals a RRC Connection Reconfiguration message to the UE(10)(S1025). The RRC Connection Reconfiguration message includes Radio Bearer QoS, Session Management Request and EPS RB Identity.

The UE(10) shall store the QoS Negotiated, Radio Priority, Packet Flow Id and TI, which it received in the Session Management Request, for use when accessing via GERAN or UTRAN.

The UE(10) NAS stores the EPS Bearer Identity and links the dedicated bearer to the default bearer indicated by the Linked EPS Bearer Identity (LBI). The UE(10) uses the uplink packet filter (UL TFT) to determine the mapping of traffic flows to the radio bearer.

The UE(10) may provide the EPS Bearer QoS parameters to the application handling the traffic flow. The application usage of the EPS Bearer QoS is implementation dependent. The UE(10) shall not reject the RRC Connection Reconfiguration on the basis of the EPS Bearer QoS parameters contained in the Session Management Request.

The UE(10) acknowledges the radio bearer activation to the eNB 2(21) with a RRC Connection Reconfiguration Complete message(S1026).

The eNB 2(21) acknowledges the bearer activation to the MME(40) with a Bearer Setup Response message(S1027). The Bearer Setup Response message includes EPS Bearer Identity and S1-TEID. The eNB 2(21) indicates whether the requested EPS Bearer QoS could be allocated or not.

The MME(40) shall be prepared to receive this message either before or after the Session Management Response message (sent in step S1029).

The UE(10) NAS layer builds a Session Management Response including EPS Bearer Identity. The UE(10) then sends a Direct Transfer (Session Management Response) message to the eNB 2(21)(S1028).

The eNB 2(21) sends an Uplink NAS Transport (Session Management Response) message to the MME(40)(S1029).

Upon reception of the Bearer Setup Response message in S1027 and the Session Management Response message in step S1029, the MME(40) acknowledges the bearer activation to the S-GW(90) by sending a Create Bearer Response message(51030). The Create Bearer Response message includes EPS Bearer Identity, S1-TEID and User Location Information (ECGI).

The S-GW(90) acknowledges the bearer activation to the P-GW(100) by sending a Create Bearer Response message(S1031). The Create Bearer Response message includes EPS Bearer Identity, S5/S8-TEID and User Location Information (ECGI).

If the dedicated bearer activation procedure was triggered by a PCC Decision Provision message from the PCRF(70), the P-GW(100) indicates to the PCRF(70) whether the requested PCC decision (QoS policy) could be enforced or not, allowing the completion of the PCRF-Initiated IP-CAN Session Modification procedure or the PCEF initiated IP-CAN Session Modification procedure, after the completion of IP-CAN bearer signaling(51032).

If requested by the PCRF(70) the P-GW(100) indicates User Location Information and/or UE Time Zone Information to the PCRF(70).

Through the procedure above, the UE 10 which has set up a unicast bearer can continuously receive a service through the unicast bearer set up.

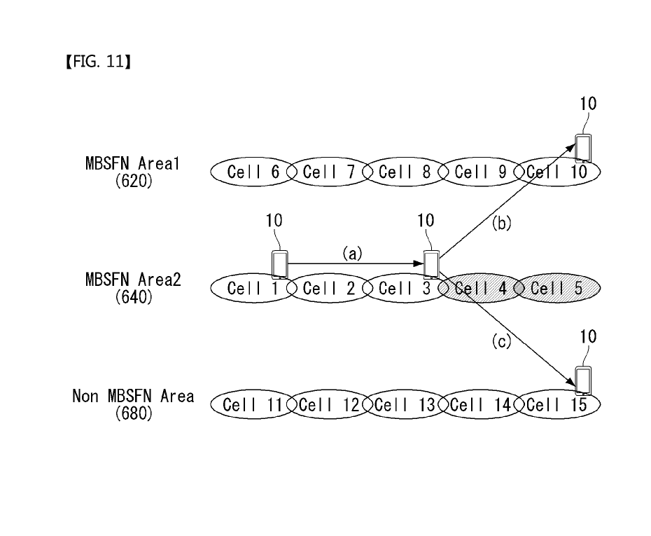

FIG. 11 is a movement path scenario of a UE according to the present invention.

With reference to FIG. 11, at least three scenarios are possible for changing the position of the UE 10. Suppose the UE 10 is located in the MBSFN area 2, 640 and receives a GCSE service through MBMS. Then the three scenarios comprise (a) a case where the UE 10 moves to a cell belonging to the same MBSFN area 2, 640, (b) a case where the UE 10 moves to a cell belonging to the same MBMS area but belonging to the MBSFN area 1, 620 of a different MBSFN area, and (c) a case where the UE 10 moves to a cell outside of the MBMS area.

(a) In case the UE 10 moves to the Cell 3, which is a cell belonging to the MBSFN area 2, 640 of a different MBSFN area, the UE 10 can continuously receive the same GCSE service through the MBMS.

(b) Also, in case the UE 10 moves to the Cell 10, which is a cell belonging to the MBSFN area 1, 620 of a different MBSFN area, the UE 10 can still continuously receive the GCSE service as long as the MBSFN area 1, 620 provides the same GCSE service.

However, (c) if the UE 10 completely gets out of the MBMS area and moves to the Cell 15 of a non-MBSFN area 680, the UE 10 becomes unable to continuously receive a GCSE service through MBMS.

In the last case, if the UE intends to receive the GCSE service again, a separate unicast bearer should be set up. However, setting up a unicast bearer for the purpose above causes additional battery consumption and a delay while switching from MBMS to unicast is carried out.

The time delay may have little influence for the case where the UE carries out data downloading, but it may exert significant inconvenience on the user using services such as real-time streaming and voice communication.

In what follows, a method for resolving such a problem will be described in detail.

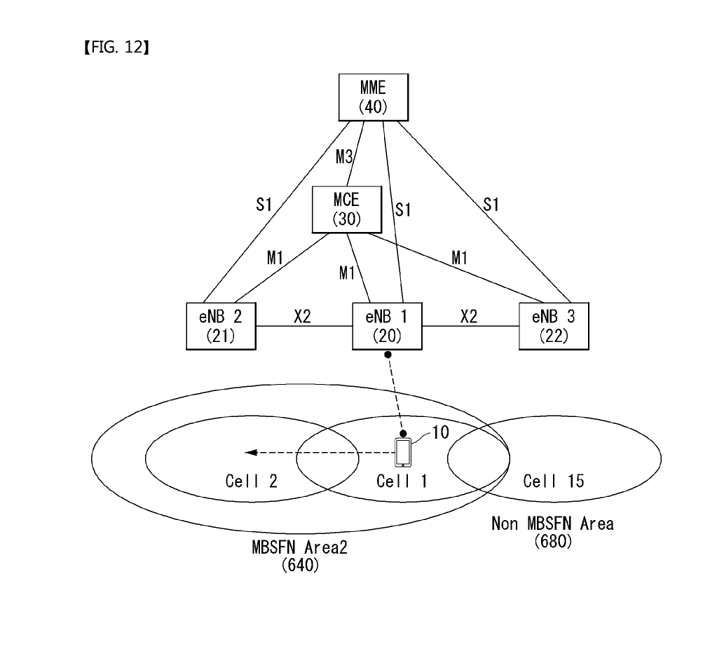

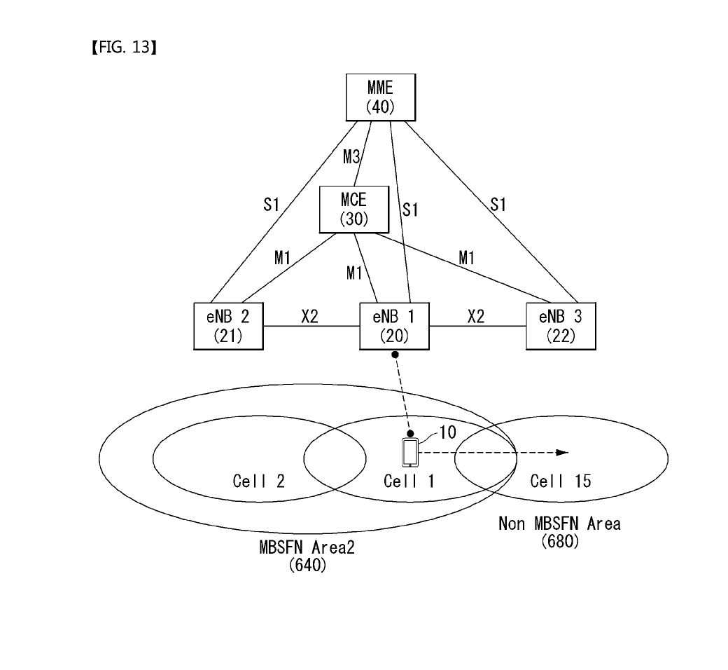

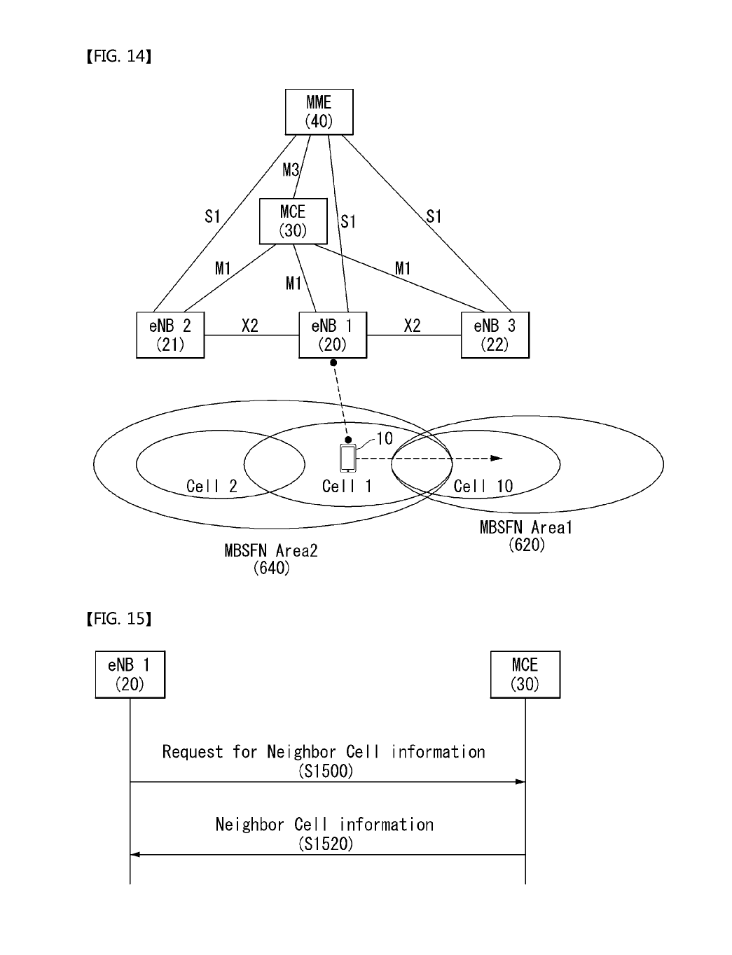

FIGS. 12 to 14 illustrate a specific movement path of a UE 10 to which the present invention is applied, where FIG. 12 illustrates a scenario where a UE moves to a cell belonging to the same MBSFN area of the UE; FIG. 13 illustrates a scenario where a UE moves to a cell belonging to a different MBSFN area; and FIG. 14 illustrates a scenario where a UE moves to a cell belonging to a non-MBSFN area in which an MBMS service is not supported.

With reference to FIGS. 12 to 14, a Cell 1 and a Cell 2 belong to a MBSFN Area 2, 640, a cell 15 belongs to Non MBSFN Area, 680, and a Cell 10 belongs to the MBSFN Area 1, 620.

The UE 10 receives the GCSE(Group Communication Service Enabler) service through the MBMS from eNB 1, 20 of the cell 1 which is serving cell.

With reference to FIG. 12, in case the UE 10, while receiving a service from the eNB 1, 20 through MBMS, is located in the Cell 2 due to change of its position (or moves thereto), the UE 10 performs handover to the Cell 2.

In this case, since the Cell 2 belongs to the MBSFN area 2, 640, the UE 10 can continuously receive the same GCSE service through MBMS from the eNB 2, 21 which is an eNB of the Cell 2.

In the case of FIG. 13, when the UE 10 receiving a service from the eNB 1, 20 through MBMS moves to the Cell 10, the UE 10 performs handover to the Cell 10.

At this time, since the Cell 10 belongs to the MBSFN area 1, 620 different from the MBSFN area 2, 640, if the MBSFN area 1, 620 supports the same GCSE service, the UE 10 can continuously receive the same GCSE service through MBMS by using the same or a different frequency.

However, in case the UE 10 fails to find the same service in the MBSFN area 1, 620 through a search of the MCCH, the UE 10 becomes unable to continuously receive the GCSE service through MBMS.

In the case of FIG. 14, the UE 10 moves to the Cell 15 belonging to a non-MBSFN area 680. In this case, the UE 10 attempts to perform handover to the Cell 15.

However, since the Cell 15 belongs to the non-MBSFN area 680, the UE 10 is unable to receive the GCSE service through MBMS from the eNB 3, 22 which is an eNB of the Cell 15.

In case the UE 10 is unable to receive a service through MBMS as shown in FIGS. 13 and 14, a separate unicast bearer should be set up between the UE 10 and the eNB 3, 22 so that the UE 10 can continuously receive a GCSE service. At this time, a delay can be caused while the UE 10 and the eNB 3, 22 establishes a separate unicast bearer.

To reduce the delay, the eNB 1, 20 which is an eNB of a serving cell has to obtain information about whether a neighbor cell or a target cell belongs to the MBSFN area, or the MCE 30 has to prepare for a unicast bearer by recognizing that the cell to which the UE 10 attempts to move does not belong to the MBSFN area. In what follows, a method for reducing a unicast bearer delay will be described in detail.

Regarding FIGS. 15 to 18, MBMS session start and stop employs the same procedure for MBMS session start and stop described with reference to FIGS. 7 and 8. A procedure for switching from MBMS to unicast and a procedure for unicast bearer set up are the same as the procedure for switching from MBMS to unicast and the procedure for unicast bearer described with reference to FIGS. 9 and 10.

FIG. 15 is an embodiment to which the present invention is applied, showing a sequence diagram where an eNB of a serving cell receives information related to an MBSFN area from an MCE in MBMS setting.

As described with reference to FIGS. 13, and 14, in case the UE 10, while receiving a GCSE service through MBMS, moves to a different MBSFN area which does not provide the same GCSE service or to a non-MBSFN area 680, the UE 10 can continuously receive the GCSE service by setting up a unicast bearer.

To reduce the delay above, the MCE 30 can inform the eNB 1, 20 through M1 interface about the information related to whether a neighbor cell belongs to the MBSFN area.

To examine more specifically with reference to FIG. 15, in case the UE 10, while receiving a service from a serving cell, leaves the service range of the serving cell due to movement or other reasons, the UE 10 performs handover.

While the handover is carried out, if the eNB 1, 20 does not know whether the neighbor cell is capable of providing a GCSE service through MBMS, the eNB 1, 20 can request the MCE 30 to transmit information about the neighbor cell related to the capability S1500.

The information about the neighbor cell may include information about whether the neighbor cell of the eNB 1, 20 belongs to the MBSFN area or information about a list of neighbor cells belonging to the MBSFN area.

As another embodiment of the present invention, in case the UE 10 attempts to perform handover, the MCE 30 can transmit information about the neighbor cell to the eNB 1, 20 even in the absence of a request from the eNB 1, 20.

For example, if the UE 10 attempts to perform handover due to change of its position as shown in FIG. 14, the eNB 1, 20 can request the MCE 30 to transmit information about whether neighbor cells, Cell 2, 10, and 15, belong to the MBSFN area. The information may include information about whether Cell 2 and 15 belong to the MBSFN area or information about a list of neighbor cells belonging to the MBSFN area 2, 640.

Through the information, the eNB 1, 10 can know whether the target cell is capable of providing the same GCSE service through MBMS.

Since the eNB 1, 20, which receives the information, can prepare for unicast bearer set up together with the eNB 2, 21 or eNB 3, 22, the UE 10 can minimize the delay to set up the unicast bearer.

By employing the method described above, the UE 10 can continuously receive the GCSE service with a minimum delay even in a non-MBSFN area.

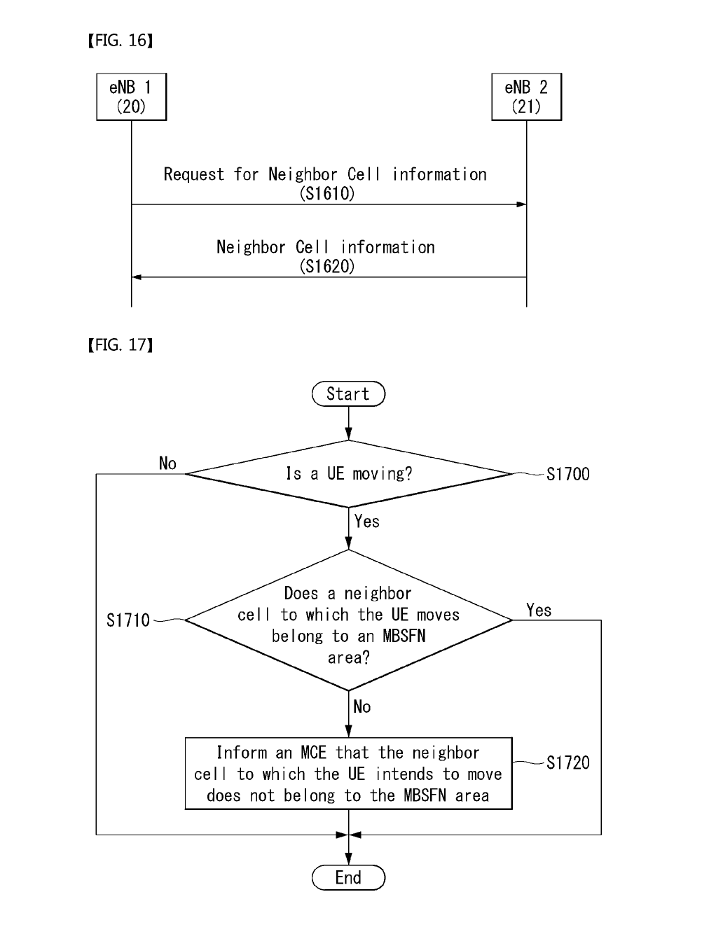

FIG. 16 is another embodiment to which the present invention is applied, showing a sequence diagram where an eBN of a serving cell receives information related to an MBSFN area from a base station of a neighbor cell.

As described with reference to FIGS. 13, and 14, in case the UE 10, while receiving a GCSE service through MBMS, moves to a different MBSFN area which does not provide the same GCSE service or to a non-MBSFN area 680, the UE 10 can continuously receive the GCSE service by setting up a unicast bearer.

To reduce the delay above, the eNBs of a neighbor cell can inform the eNB 1, 20 through X2 interface about the information related to whether the neighbor cell belongs to the MBSFN area.

To examine more specifically with reference to FIG. 16, in case the UE 10, while receiving a service from a serving cell, leaves the service range of the serving cell due to movement or other reasons, the UE 10 performs handover.

While the handover is carried out, if the eNB 1, 20 does not know whether the neighbor cell is capable of providing a GCSE service through MBMS, the eNB 1, 20 can request the eNB 2, 21, which is an eNB of the neighbor cell, to transmit information about the neighbor cell related to the capability S1610.

At this time, the eNB 1, 20 can request eNBs of the neighbor cell including the eNB 3, 22 as well as the eNB 2, 21 to transmit information about the respective cells.

The information about the neighbor cell may include information about whether the neighbor cell or a target cell of the eNB 1, 20 belongs to the MBSFN area (for example, information about whether the Cell 2 of the eNB 2, 21 belongs to the MBSFN area) or information about a list of neighbor cells belonging to the MBSFN area.

As another embodiment of the present invention, in case the UE 10 attempts to perform handover, at least one of the eNB 2, 21 or the eNB 3, 22 of the neighbor cell can transmit information about the neighbor cell to the eNB 1, 20 even in the absence of a request from the eNB 1, 20.

Through the embodiment, the eNB 1, 20 can obtain information about whether a target cell to which the UE 10 intends to perform handover belongs to the MBSFN area.

If it is found from the obtained information that the cell to which the UE 10 attempts to perform handover does not belong to the MBSFN area, the eNB 1, 20 prepares for unicast bearer set up together with an eNB of the target cell, thereby minimizing a delay that may be caused while switching from MBMS to unicast is carried out.

By minimizing a delay in the UE, services such as a voice service and a real-time streaming service where real-time data transmission is important can be supported in an efficient manner.

FIG. 17 is a yet another embodiment to which the present invention is applied, showing a flow diagram where an eNB of a serving cell transmits target cell-related information to an MCE.

With reference to FIG. 17, if the UE 10 moves to a non-MBSFN area 680, the eNB 1, 20 informs the MCE 30 about the movement of the UE 10 so that the MCE 30 can prepares for unicast bearer set up.

To examine the operation more specifically, the UE 10, being connected to the eNB 1, 21, receives a GCSE service through MBMS. At this time, the eNB 1, 21 belongs to the MBSFN area to provide a GCSE service through MBMS.

While transmitting and receiving data continuously to and from the UE 10, the eNB 1, 20 can obtain information related to the UE such as position of the UE and service strength. While transmitting and receiving data continuously to and from the UE 10, the eNB 1, 20 can determine whether the UE 10 moves S1700.

While not moving, the UE 10 can continuously receive a service from the eNB 1, 20 through MBMS. However, while the UE 10 is in motion, the eNB 1, 20 can determine whether the cell to which the UE 10 intends to move belongs to the MBSFN area S1710.

The S1710 step can use the method described with reference to FIG. 15 or 16.

If the target cell to which the UE 10 moves belongs to the same MBSFN area of the serving cell or the target cell belongs to a different MBSFN area providing the same GCSE service, the UE 10 can continuously receive an MBMS service.

However, if the UE 10 moves to a cell which belongs to a different MBSFN area not supporting the same GCSE service or to a cell belonging to a non-MBSFN area 680, the UE 10 becomes unable to continuously receive the GCSE service through MBMS, and a separate unicast bearer should be set up.

At this time, in order to reduce a delay that may be caused while switching from MBMS to unicast is carried out, the eNB 1, 20 can inform the MCE 30 beforehand about the fact during handover that the cell to which the UE 10 intends to move is unable to provide a GCSE service through MBMS S1720.

Through the aforementioned operation, the MCE 30 can know that the cell to which the UE 10 intends to move is unable to provide a service through MBMS and prepare for unicast bearer set up to continuously provide the GCSE service.

Through the method above, a delay caused by applying the procedure for switching from MBMS to unicast can be minimized.

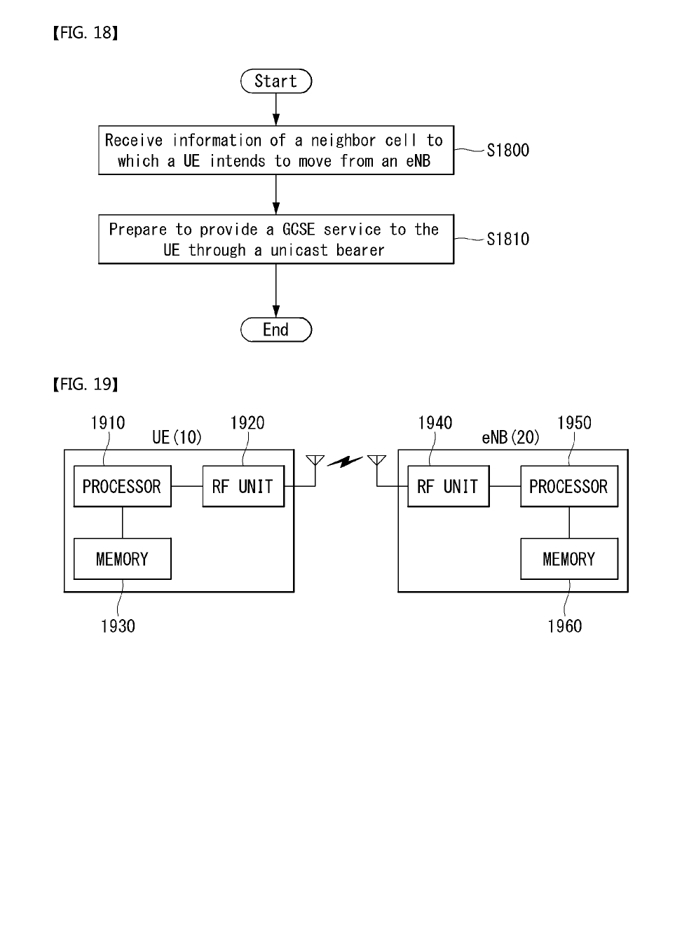

FIG. 18 is a still another embodiment to which the present invention is applied, showing a flow diagram where an MCE receives from an eNB of a serving cell information related to a cell to which a UE attempts to move.

With reference to FIG. 18, in case the UE 10 moves to a cell which is incapable of providing the GCSE service through MBMS, the MCE 30 can receive information related to the situation above from the eNB 1, 20 which is an eNB of the serving cell and prepare beforehand for unicast bearer set up.

To examine the operation above more specifically, the UE 10, being connected to the eNB 1, 10, is receiving the GCSE service through MBMS. At this time, the eNB 1, 20 belongs to the MBSFN area so that the eNB 1 20 can provide the GCSE service through MBMS.

While the UE 10 is continuously receiving a GCSE service from the eNB 1, 20 through MBMS, if the UE 10 leaves the service area of the serving cell due to its movement or other reasons, the UE 10 can attempt to perform handover to a target cell.

In this case, the MCE 30 can receive information about whether the target cell belongs to the MBSFN area from the eNB 1, 20, S1800.

That is, the eNB 1, 20 can know through the method described with reference to FIG. 15 or 16 whether the target cell is capable of providing the same service through MBMS.

At this time, in cast the target cell is not providing the same service through MBMS, the eNB 1, 20 may transmit the information related to the situation above to the MCE 30.

If the UE 10 moves to the cell belonging to the same MBSFN area of the serving cell or moves to a cell belonging to a different MBSFN area capable of providing the same GCSE service through MBMS, the MCE 30 can continuously provide the GCSE service through MBMS.

However, if the UE 10 moves to a cell belonging to a different MBSFN area not providing the same GCSE service or moves to a cell belonging to a non-MBMS area 680, the MCE 30 can know from the information transmitted from the eNB 1, 20 that the target cell is unable to provide the GCSE service through MBMS.

In this case, the MCE 30 can set up a unicast bearer in the UE 10 to provide the GCSE service S1810.

Afterwards, if the UE 10 moves to a cell belonging to a non-MBSFN area, the MCE establishes a unicast bearer immediately without incorporating additional steps (for example, a step of determining whether the cell to which the UE 10 has moved belongs to the MBSFN area) and continuously provides the GCSE service to the UE 10.

Through the method above, a UE can receive a service continuously even in the place not belonging to the MBSFN area without an additional delay or disconnection to a network.

FIG. 19 is a block diagram illustrating a UE and an eNB in a wireless communication system according to one embodiment of the present invention.

The UE 10 comprises a processor 1910, a Radio Frequency (RF) unit 1920, and a memory 1930. The processor 1910 implements a proposed function, process and/or method. Layers of radio interface protocols can be implemented by the processor 1910.

The RF unit 1920, being connected to the processor 1910, transmits and/or receives a radio signal. The memory 1930, being connected to the processor 1910, stores various types of information to operate the processor 1910.

The eNB 20 comprises an RF unit 1940, a processor 1950, and a memory 1960. The processor 1950 implements a proposed function, process and/or method. Layers of radio interface protocols can be implemented by the processor 1950.

The RF unit 1940, being connected to the processor 1950, transmits and/or receives a radio signal. The RF unit 1940, being connected to the MCE 30 or a different eNB, transmits and receives data, through which the eNB 20 can know whether a neighbor cell can provide a service through MBMS.

The memory 1960, being connected to the processor 1950, stores various types of information to operate the processor 1950.

The processor 1910, 1950 can include Application-Specific Integrated Circuit (ASIC), other chipsets, logical circuit and/or data processing device. The memory 1930, 1960 can include Read-Only Memory (ROM), Random Access Memory (RAM), flash memory, memory card, storage medium and/or other storage devices.

The RF unit 1920, 1940 can include baseband circuit to process a radio signal. If an embodiment is implemented by software, the techniques described above can be implemented in the form of a module (process or function) which performs the function described above. A module is stored in the memory 1930, 1960 and can be executed by the processor 1910, 1950.

The memory 1930, 1960 can be located inside or outside the processor 1910, 1950 and can be connected to the processor 1910, 1950 through a well-known means.

In the embodiments described above, although methods have been described through a series of steps or a block diagram, the present invention is not limited to the order of steps and some step can be carried out in a different order and as a different step from what has been described above, or some step can be carried out simultaneously with other steps. Also, it should be understood by those skilled in the art that those steps described in the flow diagram are not exclusive; other steps can be incorporated to those steps; or one or more steps of the flow diagram can be removed without affecting the technical scope of the present invention.

The embodiments above comprise various types of examples. Though it is not plausible to describe all of the possible combinations to describe various types of embodiments, it should be apparent to those skilled in the art that various combinations of the embodiments are possible. Therefore, it should be understood that the present invention includes all of the other substitutions, modifications, and changes belonging to the technical scope defined by the appended claims.

### INDUSTRIAL APPLICABILITY

A method and an apparatus for changing a service from MBMS to unicast in a wireless communication system according to the present invention has been described with an example intended for the 3GPP LTE/LTE-A system, but the method and the apparatus can be applied equally to various types of wireless communication systems in addition to the 3GPP LTE/LTE-A system.

1. A method for providing a GCSE(Group Communication Service Enabler) service in a wireless communication system, the method performed by a serving base station comprising:
providing the GCSE service through an MBMS(Multimedia Broadcast and Multicast Service) to a terminal;
detecting moving of the terminal;
receiving an MBMS state information indicating whether a neighbor cell belongs to an MBSFN(MBMS Single Frequency Network) Area from an MCE(Multi-cell Coordination Entity);
identifying whether a target cell of the terminal provides the GCSE service through the MBMS based on the received MBMS state information; and
transmitting an identification result to the MCE,
wherein a identification result indicates whether the target cell provides the GCSE service through the MBMS, and
wherein the GCSE service is provided to the terminal through an unicast bearer when the target cell can not provide the GCSE service through the MBMS.

2. The method of claim 1, wherein the transmitting the identification result to the MCE(Multi-cell Coordinator Entity) is carried out when the target cell is unable to provide the GCSE service through the MBMS.

3. The method of claim 1, further comprising requesting the MBMS status information to the MCE.

4. The method of claim 1, wherein the MBMS status information includes at least one of information indicating whether the neighbor cell belongs to the same MBSFN area of a serving cell or a list of neighbor cells belonging to the same MBSFN area.

5. A method for providing an GCSE (Group Communication Service Enabler) service in a wireless communication system, the method performed by a serving base station comprising:
providing a GCSE service to a UE through MBMS;
detecting moving of the UE;
receiving MBMS status information indicating whether a neighbor cell belongs to an MBSFN(MBMS Single Frequency Network) area from a nearby base station;
identifying whether a target cell of the UE is capable of providing the GCSE service through the MBMS based on the MBMS Status information; and
transmitting identification result to the MCE,
wherein the GCSE service is provided to the UE through a unicast bearer, when the target cell is unable to provide a GCSE service through the MBMS.

6. The method of claim 5, wherein the transmitting the identification result to the MCE is carried out, when the target cell is unable to provide the GCSE service through the MBMS.

7. The method of claim 5, further comprising requesting the MBMS status information to the nearby base station.

8. The method of claim 8, wherein the MBMS status information includes at least one of information indicating whether the neighbor cell belongs to the same MBSFN area with a serving cell or a list of neighbor cells belonging to the same MBSFN area.

9. An apparatus supporting MBMS(Multimedia Broadcast and Multicast Service) and unicast in a wireless communication system, the apparatus, comprising:
a Radio Frequency (RF) unit transmitting and receiving a radio signal; and
a processor, wherein the processor is configured,
to provide a GCSE service to a UE through MBMS,
to detect movement of the UE,
to receive from a neighboring network entity MBMS status information indicating whether a neighbor cell belongs to an MBSFN area,
to identify whether a target cell of the UE is capable of providing the GCSE service through the MBMS based on the MBMS status information,
to transmit the identification result to the MCE, and
to provide the GCSE service through a unicast bearer, when the target cell is unable to provide a GCSE service through the MBMS.

10. The apparatus of claim 9, wherein the network entity is an MCE(Multi-cell Coordinator Entity) of the serving base station or a neighboring base station.

11. The apparatus of claim 9, wherein the processor is configured to provide the identification result in case the selected cell is unable to provide the GCSE service through the MBMS.

12. The apparatus of claim 9, wherein the processor is further configured to request the MCE for MBMS status information.

13. The apparatus of claim 9, wherein the MBMS status information includes at least one of information indicating whether the neighbor cell belongs to the same MBSFN area with a serving cell or a list of neighbor cells belonging to the same MBSFN area.
